(19) United States
(12) Patent Application Publication
(10) Pub. No.: US 2015/0293651 A1
(43) Pub. Date: Oct. 15, 2015

(54) MAN-MACHINE INTERACTION METHOD AND INTERFACE

(71) Applicant: Dingnan HAN, (US)

(72) Inventor: Dingnan HAN, Beijing (CN)

(21) Appl. No.: 14/442,792

(22) PCT Filed: Nov. 13, 2013
(86) PCT No.: PCT/CN2013/087093

§ 371 Date: May 14, 2015

(30) Foreign Application Priority Data
Nov. 14, 2012 (CN) 201210455546.7

(51) Int. Cl. G06F 3/0482; G06F 3/0484; G06F 3/0481; G06F 3/0488

(52) U.S. Cl. CPC G06F 3/0482; G06F 3/0488; G06F 3/04842; G06F 3/04817

(57) ABSTRACT

Provided is a man-machine interaction method in a 3D multi-touch environment, which fully develops the advantages of 3D multi-touch, and enables a user to express abundant operation information with very few operations. Provided is a page browsing mode using pressure data, which enables the user to more quickly and accurately perform page browsing by using the pressure data.

### TECHNICAL FIELD

The present invention relates to methods for human-computer interaction and interfaces, especially human-computer interaction and interface methods under 3D multi-touch environment.

### BACKGROUND

Under current technologies, there already has multi-touch devices which are able to detect objects within a range of touch-screen surface. For this, the present invention provides interactive methods and interface to take advantage of the device's functions, to achieve a better interactive experience.

### BRIEF DESCRIPTION

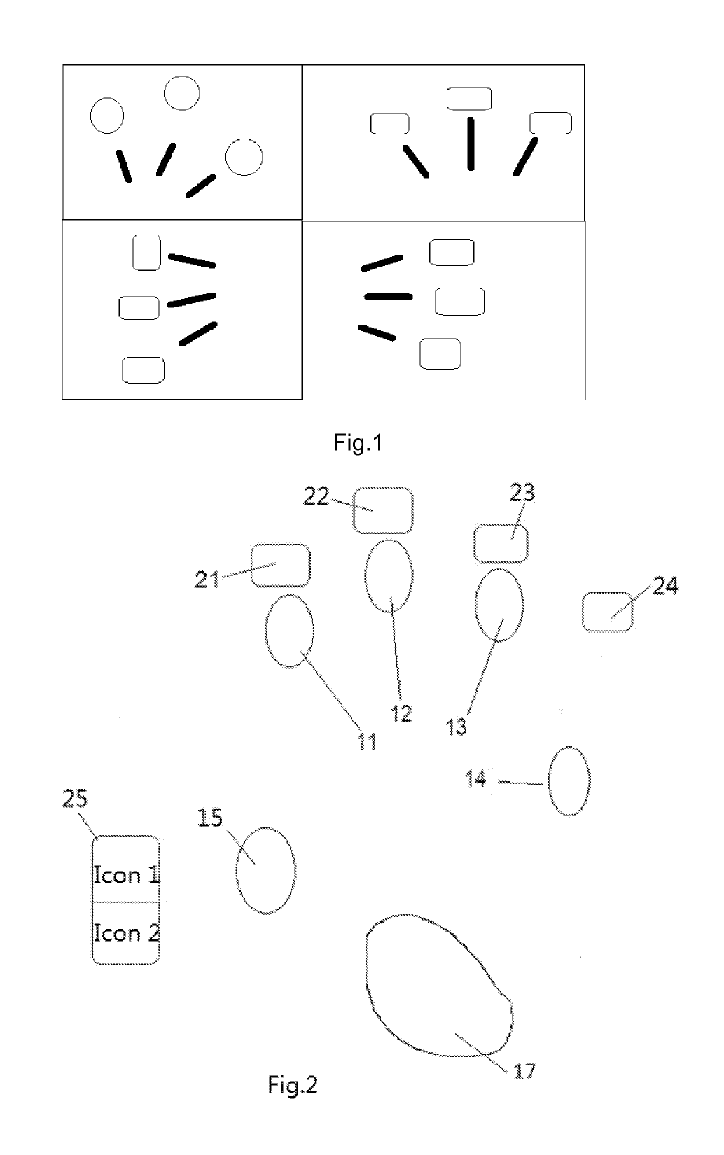

FIG. 1 is a schematic diagram of mark icon posture readily change the posture change.

FIG. 2 is a schematic diagram of mark icon and finger.

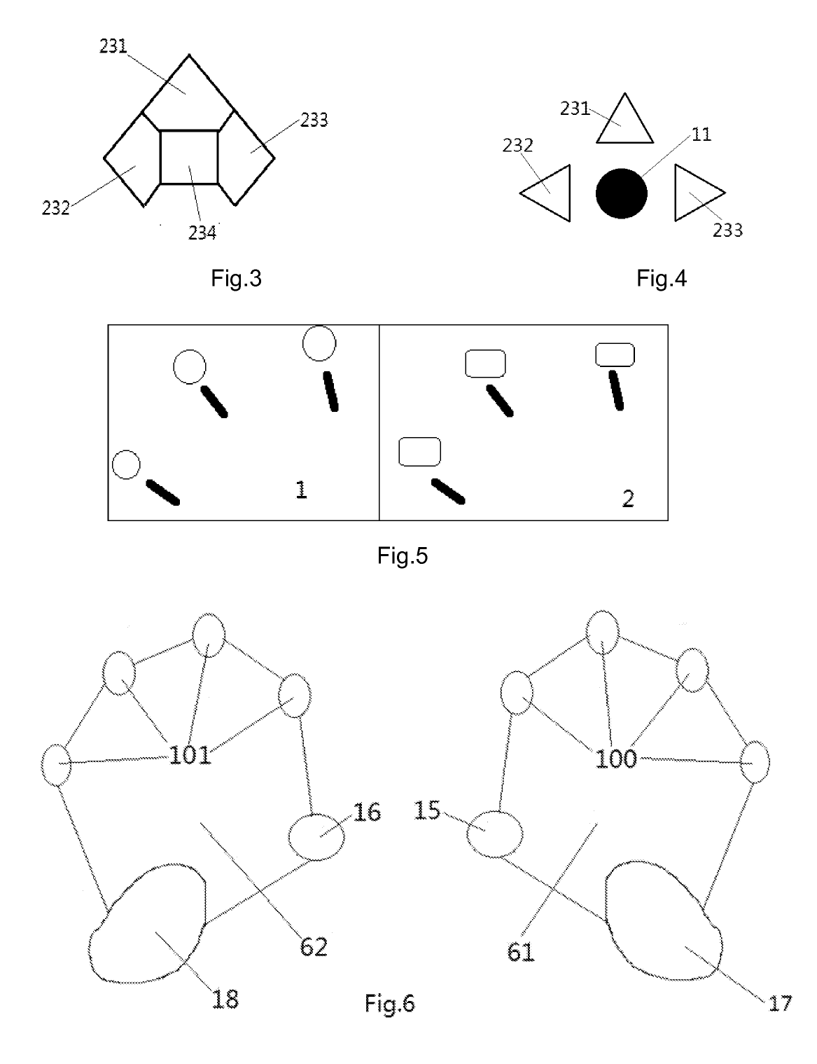

FIG. 3 is type of mark icons which are used to guide sliding operation of fingers.

FIG. 4 is a schematic diagram of mark icon changing after hand touch screen.

FIG. 5 is a schematic diagram of different relative positions of mark icon can be taken with the hand.

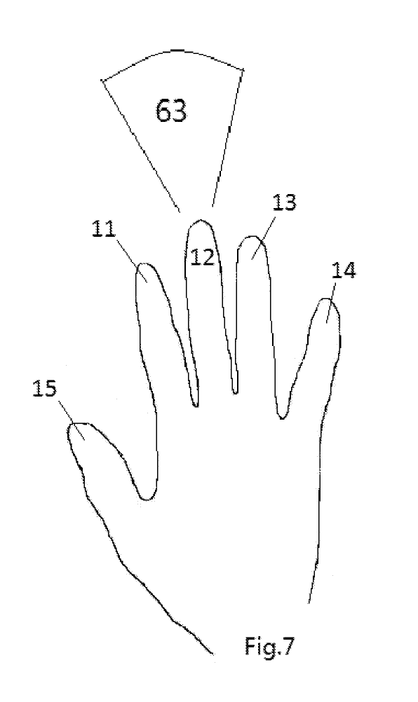

FIG. 6 is a schematic diagram of enveloping an area.

FIG. 7 is a schematic diagram of determine a tapered region according to the position and posture of fingers.

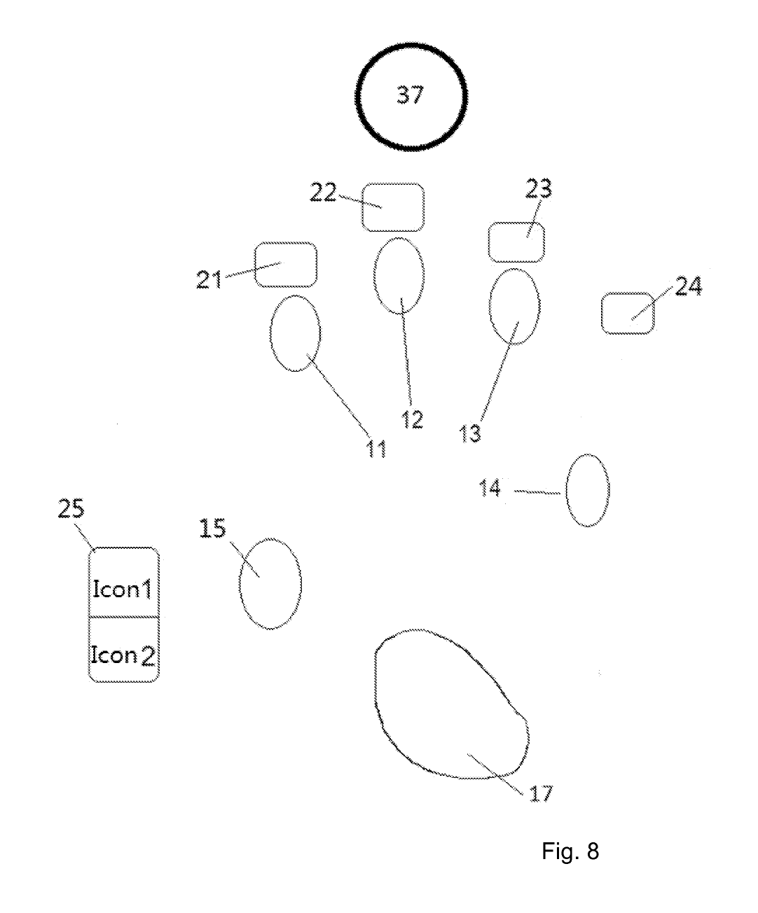

FIG. 8 is a position icon.

### SUMMARY OF THE INVENTION

The invention will treat a hand as a whole unit, through the design of a complete set of human-computer interaction method and structure and interface, can get richer user operating information, and take advantage of this information, thus enable users to very natural, simple, and precise express their operation intentions. And there are real-time graphical interfaces to guide the user, does not need memory of anything. For example, based on the human-computer interaction system of the present invention, just by a simple one-click action, the system can give four different response based on the information it obtained, and contains one or more precise position to implement the operation. A user does not need move his palm, just swing his thumb, and then uses another finger do an operation, will be able to achieve 2×3×4=24 or more kinds of different effects, while also expressing one or more a precise position to implement the operation. Current multi-touch operations are based multi-touch gesture, users need to remember a lot of complex touch gestures. In current, multi-touch gestures are unable to provide operation instructions and a precise operating position simultaneously in once operation.

The HUMAN-COMPUTER INTERACTION METHOD AND INTERFACE of the present invention contains a biological control system, the biological control system will be called as X in below.

The existing input devices, especially devices based on optical sensing, have been able to provide multipoint touch detection in 3-dimensional space. In the multi-touch environment in 3 dimensions, the system can detect objects from the surface of the screen within a certain range.

Touch panels can detect finger within a certain distance from the surface of the screen. The Panel can detect direction of each finger, System according to both the relative positions and directions of these fingers to determine which fingers are on one hand. If the touch panel detection range is more large, can detect objects farther from the Panel, such as a palm, the system can further according to location of the Palm to determines which fingers belong to one hand.

After System determined the location of a hand and has detected multiple fingers on the hand, the system differentiates between different fingers, assigns different functions to different fingers on the same hand. Fingers of the same hand doing a same operations on a same set of objects, will be able to generate different effects.

The Above described object can contains: areas on the screen, one or more locations on the screen, icons, 3D objects and all the Visual elements.

It should be understood that, the Above described “differentiate between different fingers” means fingers which are detected by the system will have different uses, for example, different fingers will be assigned different functions, icons, or the projection position of different fingers on the screen will be assigned different functions. These does not require the system to identify each specific fingers, such as the ring or index fingers. System treats each finger as an available vacancy for distribution function.

It is possible that display the icon near the different fingers, guide the user to use the corresponding finger to perform various operations, to use the function shown in icon. Easy to see the icon generally located in the position, such as a finger along the direction, distance from the fingertips. When a finger panel distance within a certain distance from the screen, finger closer, closer the distance of finger icon. As shown in FIG. 2, and the relative position between each icon relative to the screen with the finger gesture will adjust the position, so that the operator can know which icon shown in which finger function and corresponding. FIG. 2 is a schematic diagram of icon and fingers, 11, 12, 13, 14 and 4 fingers on the touch panel on the front projection screen surface, the preceding finger located at a distance of 3 cm, 21, 22, 23, 24 is the logo icon, identifies the corresponding fingers corresponding operation function, 21 and 11 corresponding. 22 and 12 corresponding to 23 and 13 corresponding. 25 and 15 corresponding to the thumb icon, the user through the use of 15 thumbs on the screen can slide in the two sub 1 and 25 icon icon icon 2 switch icon is equivalent to 25, 22, 23, 21 icon 24 directory, icon 25 different sub icons corresponding to different, 22, 21 23, 24. The thumb operation is the internal operation of the whole hand.

FIG. 1 is a finger posture icon different arrangement, the black line is the finger of the user front, the hollow box is the logo icon. Logo icon can adjust their own position, to avoid the occlusion of other graphical objects. The preceding finger before the first joint of the fingers of the user's finger, the finger is usually used for touch screen location.

In general, 21, 22, 23 icon is not a need for a shortcut icon operation by touch, it is only a guide user operation, operation can be carried out to inform the user of the corresponding finger function logo icon. Under normal circumstances the corresponding finger touch screen icon is the icon corresponding to guide users, executive function.

Logo icon can also be used to guide the user to the corresponding finger other operations: slide your finger across the screen, the corresponding fingers than other fingers are more close to the screen, press the corresponding finger screen operation. The corresponding fingers than other fingers are more close to the screen: refers to the corresponding fingertip and screen surface distance than other fingers, such as lower than 2 cm, and the distance between the surface of the screen in a certain range, such as distance less than 3 cm, the implementation tips and the corresponding icon the function of fingers.

In order to avoid the influence of some common operations of users, in addition to cooperate with both hands operation situation, under normal circumstances can be set to click on the general finger still regarded as the general operation, only double click, slide, press the screen to the specific direction of the operation, was captured for association with X.

You can also set for, only when the system is informed, for example to detect or judgment to a plurality of fingers users stretched out at the top of the screen in a certain range, only show icon. For example, if the user single hand operation screen, the user to hold the device's hand thumb on the top of the screen, the system does not display icon for the thumb; for example the user's hand on the top of the screen, but only stretched out a finger, the fingers are in hands, the system will not be the finger distribution function in X; another example system can be set to only the user's hand stretched to a certain extent, the system will start the X, for the different functions of different finger allocation on X, and display the logo icon, stretch hand to the extent to which the X will be launched by the user can be customized, such as user will stretch hand to a certain extent for the record system, only the fingers of one hand the distance is greater than the degree of stretch, will start on the hand of X trigger system.

It should be understood, not necessarily real-time Logo Icon with the corresponding finger moves, fingers moving on a small scale icons need not follow mobile, they don't have to be always in the direction of the finger finger extension line, as in FIG. 5, the black line is the user Finger front, the hollow box is the logo icon. FIG. 5 left in the first group, is located in the extension line of Logo Icon finger, right in the second group, is located in the corresponding icon finger side, which can avoid the tip of the finger user object occlusion. As long as their logo icon in the whole hand gesture to larger rotating screen, you can rotate, intuitive perception and Logo Icon finger corresponding relationship can be as long as the users. Make the user have a logo icon and finger sense is not corresponding to a single icon position, relative position between the plurality of icon to each other, or a plurality of icon established line and relative attitude determination and screen, the fingers of the user's line and screen attitude is consistent, can let users feel the corresponding the relationship between the icon and the finger.

The icon does not move to fully comply with the gradient of fingertip to arrange, if the gradient between the icon is too large, will let users feel messy.

If the icon to guide the user can use a finger to slide and other operations, without touching the screen icon in the finger can be used, as shown in FIG. 3 style, 3 horns and 231232233 respectively is touching the screen corresponding to the corresponding direction of the sliding function of the finger, 234 fingers touching the screen said not slide left immediately the screen will perform 234 functions, also can not have any function, users click on the screen is a normal finger click operation, only the slide will trigger the function icon. When the fingers touch screen, the icon can be changed, become the style shown in FIG. 4. FIG. 4 shows the icon, 232 and 233 out of 234, were close to the corresponding 11 fingers on both sides, and become the arrow shaped, to prompt the user to perform the corresponding slide icon display function. 232 and 233 sliding direction of the identified with the corresponding finger the direction pointing angles can be fixed, for example, as shown in FIG. 4, 232233 respectively guide user to perform logo function to the finger slide finger, so that the user can very natural swing finger or wrist, finger to finger the left and right sides of the sliding 232233, trigger identification function. Can be set to 232 fingers along the sliding direction of the logo, the 232 will be highlighted, prompting users now choose this function, users need to slide your finger along the direction perpendicular to the 232 mark, the function will be selected to be performed, in order to avoid misoperation.

232 and 233 sliding direction of the identified with the corresponding finger angle may also is not fixed, regardless of how the 232233 finger gestures, always point to the window on both sides, so that when the user along the vertical direction of the sliding window fingers, is not easy because of sliding straight enough, unconscious to the finger on both sides produced slide and trigger misoperation thus, the vertical direction along the window sliding fingers can be assigned to the rolling window contents of commonly used gestures do not affect each other, and the identified function 232,233.

Because the icon is a guide icon, the user does not need to touch the icon and executes the corresponding function, so the fingers touching the screen when the corresponding finger of a user when the icon does not need to move, easy to finger beneath the touch position, but should be along the direction of the finger, a finger before a distance, so that users can clear the icon shown the function of the corresponding fingers. When the system detects the corresponding finger touch screen, the system that executes the corresponding function. When the icon function is executed, the icon should change, for example, highlighting the icons, change the icon style or color icon, inform the user of the corresponding function is executed.

For the functional menu some window level, such as browsers in print, save as, brightness player in the regulation function of the menu window, if not in contact with the surface of the screen in the finger on the show will make users feel the way. Therefore, the system can be set to only detect more than 3 fingers touching the screen at the same time, will show signs of each finger icon, the corresponding function. Then, the user through one or more determined to use the logo icon which finger corresponds to the function of the following two methods as below:

(1) increase the corresponding fingers on the screen to express the pressure to use the corresponding finger. For example, in FIG. 2, users increased pressure 11 fingers to use 11 finger marks the corresponding icon on the function;

(2) you can also set up other fingers which finger that you want to use the corresponding function. For example, in FIG. 2, with a hand on the user's 11, 12, 13, 3 fingers and touch screen, which shows the system Logo Icon prompts each finger function. Then, the user to keep 11 finger does not leave the screen on the screen, slide your finger 11 and 12 fingers, 13 fingers away from the screen, said to use 11.

Further, in order to avoid misoperation, the system can also be set for users to use after that which finger, sliding finger corresponding to confirm execution icon function, avoid misoperation. You can also use FIG. 3, FIG. 4 shows the icon, let the fingers to perform different functions in different direction sliding.

The system is selected the user's finger, index finger, ring finger, give a variety of functions.

In some cases, the system has 3 options, but only detected 2 fingers. At this time, the system according to the detected image, according to the location, the size of the finger shape, which finger is not detected by the judge, for example, under normal circumstances, the middle finger and index finger will be closer to the distance from the screen, easy to detect, which will always be some prominent than index finger. The system according to the detected finger, judge not detected by the position of the fingers, such as finger position, and according to the judgment of the position display icon, to inform the user of any other functions not assigned, please other easy to use fingers close to the screen to enable the system to assign functions to them. When the user wants to use the ring finger, the ring finger will close to the screen, the system will detect the ring finger. After the system detects the ring finger, according to the detected position adjustment and ring finger corresponding to the icon position, and gives the ring finger on the function icon. Because people do not know in the right hand, did not detect the thumb/palm of the system did not detect index fingers are still unknown, but usually this system to be of no great importance because the system only care about, the function of non rationing of any one user to facilitate the use of finger on it. If the user will be other fingers in this hand close to the screen, as long as the system think this finger combined, will be the same function assigned to it.

In order to realize the users hand to the different fingers of the same operation on the same set of objects, can produce different effects of the human-computer interaction, one of the following ways: 1 program system for each detected and assigned the function of finger tracking, the corresponding function is triggered when the root the finger executes a preset operation;

2 different fingers were detected on the touch screen or touch the projection position as a function of the regional position in real time with different functions, when a region is touched and on the implementation of the corresponding operation when the preset function is triggered. This method also needs to be detected is assigned to each finger distinguishing function treatment and tracking. This method is easy to cause the misoperation, is not recommended.

The thumb is a special finger, the other fingers can be used to switch the corresponding function, such as thumb touch screen, or slide on the screen, while the other fingers function switch icon.

If the icon is a need to use the icon icon by touching the functional icon, the icon should have the following characteristics in one or more:

(1) the icon should be able to adjust its position, always in the corresponding position when the finger is easy to click on the icon, followed by finger 6985 displacement icon can not follow real time mobile, but when moving in large distance, such as more than 1 cm, with the mobile icon should adjust its position, to facilitate the touch of a finger;

(2) when touching or will come into contact with the panel, the icon should move itself to the corresponding finger beneath to the touch of a finger. 2, interactive operation and interactive interactive object location.

Different finger of a user is configured with different functions, each finger has a logo icon corresponding to guide users to operate.

Perform the operation, determine the corresponding function of each finger, sometimes need a target region or location. According to the object region or location within the X, determine the various elements, such as the fingers of the corresponding function, icon position and content etc. Or as X operation object or location or region.

These areas or locations or areas within the position of objects called “interactive object”.

To determine the object location is called interactive location.

The interactive operation of the object is executed, the objects, or objects will have an impact on X.

The system will be based on the corresponding object, determine the X elements, such as display icon corresponding to the corresponding fingers, determine the distribution function

X can also have multiple groups of different uses of the interactive object.

X can provide a lot of position as an interactive position, is used to determine the interactive object. You can use the position including but not limited to:

All kinds of graphic elements in the 1.X position, such as icon position, at some time, can also be dedicated to display one or more icons, called the position of the icon, dedicated to providing interactive position;

2 finger position;

3 according to the multiple parts of the whole hand, for example, a plurality of fingers back, can also be added to the palm, thumb, a contour, determine the contour area within the region, or the object. For example, in FIG. 6, 15 is the right thumb, 100 4 fingers of the right hand, 17 hand, which together determine the region 61; in FIG. 6, 16 is a left thumb, 101 is the 4 fingers of the left hand, left hand is 18, they identified 61 areas

When using the graphic elements to determine the interactive objects, graphic elements can make the appropriate deformation, such as the tip to help select the accurate position, or translucent coverage to the interactive object above, or surrounded by interactive objects etc. For example, in FIG. 2, when the 11 fingers on the top of the screen 3 cm, 11 fingers and 21 fingers with 11 icon moving together with the 21, when the icon after 51 above, 21 Logo Icon surrounded by 51, if the use of 11 fingers to prompt the user to touch the screen, the operation will be executed as 51.

It should be understood, interactions are not confined to the position below the corresponding graphic elements or fingers, can also be a specific area near the corresponding graphic elements or fingers in region. When using visual elements: “such as fingers, graphic elements, etc.” area or nearby objects within a certain range as interactive objects, the corresponding area or location can be highlighted, to prompt the user. For example, as shown in FIG. 7, in the game, 12 finger touch screen, to the region 63 Spitfires, so when the 12 fingers closer to the screen than other fingers, 63 or 63 in the target area will be highlighted, prompt the user if 12 fingers touch the screen, the object will be carried out in the highlight area of finger 12 the corresponding function. Zone 63 is along the direction from the 12 fingers, 12 fingers fingertips exude a cone, the user can change the 12 finger pointing in different directions, turning the region 63 divergence.

Below to explain some specific design.

1. Each finger cell using independent interactive object positions. A finger cell includes: a finger with its assigned icon, such as icon which is used to mark the function of this finger, and position icon, and other types icons. The position of interactive object. Each finger cell using independent interactive object positions. A cell can have multiple interactive object position. Thus, users can use the same finger unit, and determine the implementation of what operation and perform an operation on the object.

One has the same finger unit using multiple interactive location example: icon of a finger in the use of X as shown in FIG. 3, when the finger click on the screen, the object 232 below will be carried out 232 identification function, object 231 below will be executed 231 identification function and so on.

A typical example is X operating system to determine the location of the object based on the position of the touch of a finger. Use the same finger, and determine what action, and perform operations on which object, which will greatly enhance the work efficiency of users.

For example, FIG. 2, system detected three finger on user's one hand, distance from these finger to screen surface is 5 cm. Along the direction of the fingers, icon 21, 22, 23 is posited respectively at 5 mm location from projection positions on screen of finger 11, 12, 13, icon 21, 22, 23 show the current function of finger 11, 12, 13.

When finger above on object 51, system will according the object 51, to determine what interactive operation are able to be provided when the object 51 as the interactive object, and then to determine what function will be assigned to finger 11. For example, if the object 51 is a folder, system according to the object 51, can provide three option: (1) “deletion”, (2) “cut”, (3) “copy”, according to pre-setting, the option whose code is (1) will be assigned to finger 11, thus finger 11 will be assigned (1) “deletion”. At the same time, the icon 21 which is corresponding to finger 11, will change into an icon which means “deletion function”. If the finger 11 click the object 51, the object 51 will be deleted. If the finger which on the object 51 is the finger 12, the system will according to pre-setting, assigns the option “cut” whose code is (2) to the finger 12, and the icon 22 which is belonged to the unit of finger 12 will change into an icon which means “cut function”. In fact, the finger 12 is above on the object 52, object 52 is a picture, such as a photograph of twilight floating clouds in the sky. The System according the object 52, to provide a series of options, for example, (1) “identify people in the photos”, (2) “pick color”, (3) “share this photo”, and then, assigns the “pick color” function which number is (2) to the finger 12, and the mark icon 22 of the finger 12 will change into a colour picker icon simultaneously. Pick color needs precise operations. For this, when the system finds the current operations require precise position, increase the distance between icon 22 to the projection position of fingertip on the screen, from 5 mm to 1.5 cm, system according to the position of finger 12, show an icon 32 between the icon 22 and the fingertip of finger 12, icon 31 has A pointer-like tip, easy to exactly select a location. It can also use another design, no show another icon, but the icon 22 deform into an eyedropper style pens.

If the finger 12 touch screen, object 52 will become the X operating object. At the same time, the Logo Icon 22 for a pencil style, keep finger 12 and screen surface contact, finger 12 mobile will cause the icon 22 move in the same direction moving, but marked graph standard 22 mobile distance will be smaller than the finger 12 movement distance, which in a small range achieve further precise operation. Then a user can be used the other hand holding pen in other screen drawing position, the system will be based on finger 12 as the color of the color pen pickup for determining handwritten pen handwriting color.

If the finger 11 touch the object 51, object 51 will become be manipulate x objects. At the same time, the icon 21 can change icon in the 21st from the delete icon into arranged along the direction of the fingers of two icons—“delete” and “spam, and near to the fingers of a user, Icon 21 and not to be moved to the user's finger beneath, and finger 11 is corresponding, does not need to touch can operate icon in the 21st to the finger 11 near is to cause the user's attention, said users now to perform the icon displayed on the 21st of operation. Keep finger 11 does not leave the screen, finger 11 can along the direction of the fingers slide back and forth, to switch between the two the “delete” and “spam” icons, icon of the currently selected functions will be highlighted. After determining to use “spam” function, maintain “spam” icon to highlight your fingers along the vertical to the finger in the direction of sliding direction, it will confirm the execution of the current is the function of the highlighted icon.

You can set 11, if the finger touch screen and a wide range of sliding, delete multiple objects within the scope of the slide.

It should be understand that, in addition to the finger as the user can easily recognize the markers to guide the user to determine the location of object interaction, can also position determining the position of the object interaction using other position and finger associated with the object. Interactive object location does not have to be set to below the finger.

2. The whole hand, or one or more fingers cell, use a common object position.

For example, as shown in FIG. 8, when the detection system with a hand on a plurality of fingers, the system will in front of a plurality of fingers, an intermediate position, display a location icon. The position of the icon is used to determine the interactive object positions of the fingers on the hand. Icon position 37 shape can change, usually is a punctate, when in an object above, along the edge of the object surrounded by live objects.

For example, when the position of the icon 37 object located at 51 above, 37 position icon disappeared, blue edge surrounded by 51. At this point, the system according to the object of 51 can provide (1) “delete”, (2) “cut”, (3) “copy” etc. three options, respectively and sequentially assigned icon of the corresponding function to finger 11, 12 fingers, fingers 13 three finger, Logo Icon 21, 22, 23 also showed tips. At this time, even if the finger in the object above 52, finger 13 Logo Icon 23 in 53 above, are not to icon, 21, 22, 23 shows icons and finger 11, 12, 13 features produced. If the 11 finger click on the screen, the object 51 (1) delete operation.

Another location design is shrouded selection. This way the position can give the whole hand more fingers can also be shared, only assigned to a specific use finger. This design is difficult to provide accurate “point” position, a large area or object is suitable for determining/selection. For example, in the game, the user selects a left hand side of the armed units, keep the left hand away from the screen, the user's right hand 11, 12, 13, 3 fingers respectively corresponding to different attacks, of which 12, 13 corresponding mode of attack is to attack a single object, corresponding to 11 fingers the attack for indiscriminate attacks on a region, if the user with 12 fingers touch an enemy object, is touch where the object will be left from our armed units attack, if the user is using the fingers of your right hand 11 touch screen, the object is left armed selected our side will be no difference in saturation the attack by the right hand covered area. In order to allow users to realize clearly the area is assigned to the palm over the unit 11 fingers, 11 fingers can be unit Logo Icon, the 11 fingers below, and palm shrouded region is set to the same style, for example, if the finger 11 corresponding mode of attack is to hit a ball from the sky lightning, your finger 11 icon is a group of blue and white ball lightning, 11 fingers below a certain range, and the whole hand shrouded area, there are blue and white balls of lightning and rolling, with 11 fingers close to the screen, as shown in FIG. 6 palm rolling ball lightning in 61 areas covered. And the brightness will be more intense, and a growing voice; and unit 12 fingers and 12 fingers below the logo icon display and 12 corresponding attacks to match the content, such as finger 12 fingers below the front of the burning flame, thus, the user can clearly recognize the right hand below the 11 area is belong to the finger. When the user's finger 12 in allied units above, finger 12 function will change as a cover, and display the corresponding Logo Icon, finger 12 hits allied units, left hand selected our armed units will carry on the protection to the touch the fingers of your right hand 12 by the object. Light below 11 fingers, palms shrouded in area 61 lightning, can be regarded as the logo icon. This example reflects the flexible application of logo icon.

There are many kinds of methods to determine/allocate the interaction location. These methods can be mixed use, which can provide a better experience. For example, interactive objects have a variety of applications, interactive objects for various purposes are determined according to the method of distribution, different. For example, determined using a method for determining the function of the fingers of the interactive objects, determine the operation is performed using another method. Such as Logo Icon to display the function is determined according to the whole hand shared special “icon position”, but each finger function and to perform the operation of object, each finger unit use independent position determined. In the following example will illustrate, show the advantage and the use of this method thought. Another example finger 11, 12 use finger within each unit provides the interaction location and finger 13, sharing of 14 palm shrouded regions identified 61 as position to interact. Thumb 15 without interaction position, thumb 15 for switching finger 11, 12, 13, 14 of the function, which can be in the original basis to provide more than 1 times the number of function.

System will a group of function distribution to different finger should follow certain rules, so that in the same situation, according to the same object with a root is to detect and track the fingers can be assigned the same function. Let the user operation can be repeated.

Users sometimes wish with the middle finger and index finger to use x, sometimes with the middle finger and ring finger to use x, sometimes with a hand three or four fingers to use x, sometimes with two hands on the six fingers using X, if the use of a fixed root specific fingers, such as ring finger fixed function allocation, will not be able to make full use of user is currently assigned to x fingers, two fingers on two functions, but because the functions to be allocated to the fixed finger and function distribution to the fingers. And the existing touch screen tracking range is limited, touch screen on the top of the screen to the detection range is relatively small, such as less than 2 cm, it is prone to be detected fingers is not recognized. Therefore, the application provides a way of distribution, which can in the user free to different finger assignment to x make full use of each finger and intelligent as possible care users habits, automatic function of priority in the allocation of custom users like fingers.

For example, in one case, which is called 1. In 1, according to the 51 object system has 6 functions can be assigned. These six functions in accordance with the rules of procedure for the determination of the divided them into several groups, generally 10 groups, such as assigned to sequence number 10 units, numbers greater than 10 unit will be used for being forced to give the number of fingers, such as thumb may be forced to number 11 and 12. Multiple function can be assigned to a unit, within the same unit will be assigned to the same root finger, this application offers a variety of let a finger is corresponding to a plurality of functions and interface, such as thumb switch marked with the multiple of Logo Icon, the specific in what form can be set by the program and users themselves. Of course, if necessary, especially for some commonly used functions, 1 functions can be assigned to multiple units. Grouping is varied, for example, it can be used with a set of functions is given the same number at the beginning of the number, these are common methods.

System can also according to the currently number of fingers detected by screen, take different preset rules will function assigned to the unit, such as the six function to assign, if the detected user stretched the hands to show willing to start the X system for two hands, with each unit will only be assigned a function of rules, if the system is only detected user stretched out the hand to show willing to on the one hand to start the X, with each unit will be assigned under the rules of the two functions.

System give a group of numbers to each detected finger according to certain rules, a unit will be assigned to the same number of fingers. Number can be determined by the program, also can be customized by the user, such as in accordance with the fingers of the right hand from left to right sequence conferring 1-5 number according to the, the fingers of the left hand from right to left order shall be 6-10 number in accordance with, such as right-handed users only the index finger and middle finger was detected, they will be numbered 1, 2, if the user's right hand only the middle finger and ring finger were detected, will also were numbered 1, 2. Program and users can be user specific finger, for example two thumbs, forced numbers for 9 and 10, and even forced to number 11 and 12, even not be numbered, to control the assigned to the function of the thumb. Such as thumb is forced to number 11 and 12, the program so far as to be distributed to the thumb of the distribution function to unit 11 and 12. Program can set a function can be allocated to the priority which hand which a specific fingers, such as thumb, middle finger. When the system is able to determine the position of the finger, the function will be assigned to the finger, and icon is displayed in the corresponding position, when cannot determine the position of the finger or unable to detect the finger, ignoring this request, to assign this function to the fingers. Can also be forced to assign a function to a specific finger. If it is not possible to determine the location of the thumb nor the functions assigned to the other fingers.

Users can also automatically for each finger of a user to set up a group of numbers. For example, users will be their most like fingers set to 1 fingers. This program can require several functions very commonly used a few priority assigned to the user by the number of 1 fingers. At the same time, the system according to the rules of the fingers were detected in the number, priority will be No. 1 assigned to users is set to No. 1 finger. So the programmer as long as the most commonly used functions assigned to No. 1 unit, will be able to these features give users the most like to use fingers, and not know the users like to use a finger. And if the user favorite fingers is not detected and function within the unit 1 will be given other numbers for No. 1 finger, without having to worry about distribution function does not go out. So the program as long as simple will function from unit 1 to sequential allocation, will be able to function assigned to the most suitable for the operation of the fingers.

Thus, by taking the combination of dynamic allocation with the fixed allocation and use different priorities to be coordinated, makes full use of the fingers of the user, especially at this time of the system to detect the finger. That did it in the same situation below a root is detected and keep track of the fingers can of the same object always corresponds to the same function, and can make full use of the fingers was detected.

In some cases, especially users in continuous intense operation. If the touch screen of the detection range is relatively small, such as less than 2 cm, it is very prone to temporarily of a finger for leaving the detection range of the screen and lose track of, this case should not immediately to still be detected the finger number change at the top of the screen, because it is likely that users do not carefully.

This HUMAN-COMPUTER INTERACTION METHOD combined with duo hands operating environment, there will be good results.

For example, in the game, multiple units are simultaneously displayed on the screen, including: our fire ships, enemy fire ships, and our supply ships, enemy supply ships. User use finger 11 of hand 111 touch our fire ship 55, keep finger 11 does not leave screen, at this moment, if system has detected another finger of hand 110 approached into a range, such as within 5 cm to screen, it will according to out fire ship 55 which is touched by the finger 11, to determine show what icon to fingers of the hand 110.

such as: index finger corresponds to shelling, middle finger corresponds to missile attack, ring corresponds to head-on intercept. keep finger 11 does not away from the screen, thus warship 55 which is touched by finger 11 will firepower the enemy fire ships which is touched by the index finger of hand 110, missile attacks the objects which is touched by the middle finger of hand 110, or head-on interception by finger clicks the object. Our fire ships 55 may be sailing in real time on the screen moves, it may leave your finger position below the 11, but as long as fingers touched our fire ships after 55 11 without leaving the screen, the system assumes that users must always maintain a selection of 55.

However, when the enemy is mixed, we supply ship close to the enemy, may be in the range of 3 fingers, it will have a different enemy units, thus it is difficult to determine the corresponding finger function and should show the logo icon.

At this time, can each finger according to the object of each finger below the finger to determine the corresponding function, and display the Logo Icon user guide. For example, the index finger in the above enemy units corresponding to shelling, located in friendly units above, the corresponding release protection force field. The system will be based on the index finger position, for example, is located below the tip of the index finger or below the object, determine the corresponding index finger function and index finger along the direction, distance 2 cm index finger position display icon, 2 cm distance is to prevent the objects near the index finger.

For example, the index finger in enemy units above, corresponding to the shelling, shelling and display icon. In the finger position for example, the index finger in enemy units above, corresponding to the shelling, shelling and display icon. In the friendly units above, display cover, and display screen icon.

However, in some special cases, there are many different attributes of the unit, the user does not need to browse a clear purpose, he need take a look at that what operations is available of each unit, and then to decide which one operating unit, the setting may be some inconvenience, because users will need different fingers through the object in order to know the above each finger to this object function. This design can be used in multiple fingers unit share an interactive location. This can be based on specific fingers, such as finger position, to determine the icon of each finger of the hand 110. As shown in FIG. 8, can also display a special multiple fingers shared location icon 37, designed to determine the icon 110 more fingers of the hand. 110 should be left here, in order to facilitate the use of the right hand as Tutu 8 110 on the map.

A finger cell could comprises a plurality of elements, a part of a common element can be determined only according to the position of the whole hand 110. Below provides two useful design:

(1) 110 on each finger icon, other 110 fingers on the ring finger, for example, the index finger, the corresponding function will be according to the distance of 110 or a certain distance in front of the icon 37 to determine the position of 110, namely, when the ring finger, index finger touch screen, will be performed according to the middle finger mark to determine the position of the function icon. The object of execution according to the middle finger or icon to determine the position of 37.

For example, in which is located above the one supply ship, then the index finger corresponds to the “launch protection force” function, and display the corresponding icon, when the index finger touches the screen, even if the index finger touch is the position of other objects, will remain on the middle finger's supply ship below the implementation of “emission protection force” function.

(2) Another design is when the system determines the users to use the corresponding index finger, for example, performing the operation, according to the object position of the index finger and index finger operation determine the corresponding function, and display the corresponding logo icon. In this design, any time of each finger function are based on objects of various elements within the finger unit where they are determined, such as determined according to their own interactive objects to determine the position of the. Only each unit within the icon according to a common position on the 110 hand, refers to where the unit provides the position for example, or icon shared 37 position.

For example, when the whole hand 110 fingers above the surface of the screen position of 3 cm, according to the middle finger to determine the position of each finger of the hand icon 110, when the system detects the user's finger from the screen surface is less than 2 cm, and lower than the height 1 cm above the thumb away from the other fingers, or is the distance from the surface of the screen not more than 3.5 cm, and lower than the other fingers above the thumb outside 3 cm, the system is switched according to the index to determine the position of the index finger and the corresponding function to display the corresponding logo icon.

That is, when all the fingers from the screen is far away, and almost at the same height, the system that the user can perform what operations on each object in the observation, on the basis of the whole hand common position, such as W1 or a logo icon to display icon to determine the position of each finger according to the object, but when the system detect the user intention to perform operation with the specific fingers, such as specific finger touch or start close to the screen, according to the specific operation is still the object to determine the position of the finger and finger function corresponding to the specific.

For example, between 3 fingers of each user and the screen distance is not much difference, for example, is within 1 cm, and the distance between the surface of the screen height is more than 1 cm, according to a position shared by the whole hand 110 fingers display icon of each finger, but when the specific index finger, such as screen distance the distance ratio is 1 cm less than the other fingers, and the finger screen distance of not more than 2 cm, the index finger icon will be determined according to the position of the index finger or the index finger unit elements in position. Need to pay attention to the function, from first to last, the index has not changed, always is provided according to the index finger itself within the unit to determine the position of.

Intelligent sliding. According to the bottom and then provides several pressure to achieve a more intelligent and simple operation.

1. when users read e-books or electronic document, by sliding the screen from the edge to the center of the screen, to the page. For example, users from the right side of the screen slide to the left finger, back flip. The system can according to the user's page to determine how much pressure. Such as when the user great pressure to hold down the screen and slide your finger, the system will according to the size of the pressure of the sliding of the fingers of the user to determine climbed over how many pages, the pressure is high turned more pages. You can set a gate value, pressure in the gate below, regardless of the size of the pressure, just turn the page. When the pressure in the gate level above, the system only according to the size of the pressure is determined to turn the page. Because the user is very precise control of the pressure, this page is not a precise fuzzy number. In order to increase the precision of the turning of the user, the user increased finger pressure at the same time, on the screen shows the pressure will be turned over the pages or flip pages accounted for the percentage of the total number of pages and other. Can also take another set, when a user's finger pressure is increased beyond a gate value, the system will be based on the finger of the user on the screen the length of sliding distance determined backward scrolling page.

Further, the system can monitor the user's reading habits, reading the user favorite page selection. Users liked the page contains a user to add a comment, bookmark the page, but also includes system can monitor the user's reading habits selected users favorite read pages. For example, users and over many pages, some is directly turned over the past, other stay each page stay time are not more than half a minute, end user stays on a page P1, and P1 stay more than more than 1 minute of time, and thus began the page order of backward scrolling reading, can be judged for the user is looking for P1, P1 will be considered for the user favorite pages. Such as user a forward as soon as he crossed the 100 pages, and turned back a 20 page, after a page and a page quickly turned back, the last stop on a page and start reading in normal reading speed flip, this page will be regarded as users liked the page. The so-called normal reading speed, is refers to the system according to the capacity of the page in, such as words, and users of the average reading speed, calculated a user read the page of time. A page is the user back to read the number of reading, the higher the level of love it, fuzzy flip, priority will be selected within a certain range, such as before and after the 10 pages, like pages of the highest grade. Favorite page can also bookmark the page are added to the distribution a default level of love in order to facilitate system calculated by favorite grade compared, can also allows the user to himself to the page to add favorite level.

When users use vague back flip over when, if you have a user favorite pages may turn to page range, the system will give priority to turn to users liked the page. For example, when the user sliding force finger system in accordance with the finger at this time the pressure will turn to 570 pages, but around 570 pages 20 page range is the 561 pages for users in the near 20 pages favorite page, then the system will turn to page 561 not 570 pages.

Pressure to increase the pressure has increased the pressure of pressure from another example is that when a user uses more than gate value size of pressure to hold down the screen, the system according to the user of the size of the pressure at this time showed sliding a finger will turn to the page, 561 pages is the user like a page, when users will turn to 560 pages to add to the meeting turn to 570 page, the system will increase in turn to 561 pages that stay time and special color display, even if the user can turn to 570 pages of the pressure, the system will still show flipped to the 561 pages until the user can turn to 571 page, the system will have a direct jump to 571 page. When the user begins to reduce pressure from the 571 page of the pressure, the system will reduce the number of order, in order to show the page 571-561 page. But users need to reduce the pressure of pressure system will jump to turn to page 551 to page 551. This method can also be applied to when the user's finger pressure is increased beyond a gate value, the system will be based on the finger of the user on the screen distance sliding length determine the back flip the

In view of Webpage or electronic document, the user can use the fingers on the screen, scroll the page. For example, the user to the bottom of the screen slide your finger on the screen, the page will scroll to the bottom of the screen. When the page is long, users often need on the screen repeatedly with the swipe of a finger, and wait for a period of time to see to see the position. There are two solutions.

(1) with the increase of the pressure of the sliding of the fingers of the user, the page scroll speed will also speed up, finger off the page after page to continue rolling time will also increase.

(2) the fingers of the user of the size of the pressure over a gate value, finger on the page the effect of sliding will change, page backward movement of the way, from the smooth scrolling, in full screen as a unit back flip over, also with the increase of finger pressure, the number of mobile units with finger distance turned back screen will increase. For example, when the pressure value is 2, fingers on the screen slide down 5 mm will show screen content, when the finger pressure of 3, finger on the screen sliding 2 mm will display a screen content. Fast the whole screen or page, at the same time, the system can also further show that something like a whole document or web page thumbnails, help the user locate now display the contents of the entire page position. The electronic paper book in order to save power, the general default to the entire screen is backward. Sometimes users wish to move back just a few lines, so that two adjacent sections of the contents can be displayed on the same screen. In this regard, uses and the opposite set. When the user's finger on the screen of the pressure is increased beyond a gate value, finger on the screen sliding will lead to a smooth scrolling the page and not the entire screen backward scrolling.

(3) finger on the page level sliding your finger will drag the page of the page content slide around, but when the fingers of the user of the size of the pressure exceeds the value of a gate, finger on the page in the horizontal direction sliding in the reader will correspond to flip back and forth, and in the browser will correspond to the forward backward. For example, in the browser, a finger swipe to the left is left to drag the page, but when the user to more than gate value size pressure finger swipe to the left, corresponding to the back to the front page.

when the function of finger movement/sliding event will be changed caused by the pressure exceeds the gate value, in order to prevent misoperation of user, take the following measures: if the target operation is not a smoothness of system events such as move in the current page, but is forward/back to another page or the entire screen switch to display content for a class of events, before the corresponding event is triggered should be the corresponding prompt. For example, if it is in the reader, the detection system to the fingers on the screen imposed exceed the value of the gate to the turning of the entire screen and not smooth mobile page, can mimic the physical books footer is slightly turned up the effect of, at this time if the user reduce the pressure or stop moving finger, page turn event will not occur.

1. A method for Human Computer Interaction, user selects a group of one or more objects by the first group touch points, the object can be an area, or a location, or a Graphic object, holding one or more touch points of the first group of touch points which is detected by the system so as to hold the group of objects being selected, user selects another group of one or more objects by using another group touch points, the system determines to perform what operations basing on these groups of objects, objects in different group will have different use or will be performed different operations.

2. The method for Human Computer Interaction, characterized in that the system groups the touch points according to one or more methods of below: According to the sequence of touching the screen, the touch points which touch the screen first will be grouped into one group; According to the sequence of the touch points detected by the system, the touch points detected by the system first will be grouped into one group;
According to the touch object, touch points from the same touch object will be grouped into one group;
According to which hand the touch points from, the touch points from the same hand will be grouped into one group.

3. The method for Human Computer Interaction according to claim 1, system performs different operations under different selection sequence, it means that select object A by one group of touch points at first, then select object B by another group of touch points, system perform different operations from the case which select object B by one group of touch points at first, then select object A by another group of touch points.

4. The method for Human Computer Interaction according to claim 3, characterized in that according to different selection method, the system further divides the objects which are selected by the same group of touch points into two or more groups, objects in different groups will have different use or will be performed different operations, the different selection method include one or more of below selection method: contour selection, it means that connecting a plurality of touch points of a same hand, forming a contour of an area, the area or Graphic objects in the area will be selected; multi point touch, such as the objects, which are touching selected by two fingers putting together, are in one group, the objects, which are touching selected by one finger, are in another group; by draw a selection box; different number of clicks, such as the objects which selected by double click will be divided into one group, the objects which selected by single click will be divided into another groups.

5. The method for Human Computer Interaction according to claim 3, characterized in that the operations to these groups of objects, or the uses of these groups of objects, include one or more of below: system determines to perform what operations to one group objects based on another group of objects; system creates one or more now objects based on these groups of objects, object in different group or the information from object in different group will have different use for these new objects or will as different element of these new objects; system uses one group of objects, saving the result.

6. The method for Human Computer Interaction according to claim 5, characterized in that when more than one operations are able to perform, the system give options to user by the Human Computer Interaction interface.

7. A method for Human-Computer Interaction, system detects a plurality of touch points, the system divides them into two or more than two groups, the system has determined one group of objects by one group of touch points, the object can be an area, or a location, or a Graphic object, call this group touch points as J group, the system will associate another group touch points with J group or objects which are selected by J group, the system determines the functions or effects of another group of touch points according to the J group or objects which are selected by J group.

8. The method for Human-Computer Interaction according to claim 7, characterized in that the system groups these touch points according to one or more methods of below: According to the sequence of touching the screen, the touch points which touch the screen first will be grouped into one group; According to the sequence of the touch points detected by the system, the touch points detected by the system first will be grouped into one group; According to the touch object, touch points from the same touch object will be grouped into one group; According to which hand the touch points from, the touch points from the same hand will be grouped into one group;

9. The method for Human-Computer Interaction according to claim 8, characterized in that another group touch points will be used to operate the objects which are selected by the J group.

10. The method for Human-Computer Interaction according to claim 9, characterized in that another group of touch points are used to perform 3D operations to the objects which are selected by J group, the 3D operations include one or more of below:
Change the shape of the object; Change the position of the object in the space; Change the posture of the object in the space.

11. A Human-Computer Interaction interface and system, system detected fingers of users one hand, and performs one of the following actions:
allocates different function to different finger and show icons for each finger to indicate its function; system sets the projection position on touch surface of different finger corresponding to different function, and show icons for each finger or position to indicate its function; system determines where to display the icon which need be displayed or changes the position of icon which already displayed on the screen according to the position of these fingers and the fingers relative posture to the touch surface; system allocates different function icon to different finger, when a finger touch the touch surface, system move or display the icon which has been allocated to the finger below the finger.

12. The Human-Computer Interaction interface and system according to claim 11, user uses one or more of the following methods to indicate which finger's function or which icon's function to be used: Slide the corresponding finger or icon; Increase the pressure of the corresponding finger to the screen, or increase the pressure to the corresponding icon.

13. The Human-Computer Interaction interface and system according to claim 11, system determine which objects as the Interactive objects by one or more of the following methods:
the system performs operations to the Interactive objects, or determine to allocates what functions or function icons to the finger of the hand according to the Interactive objects:
connect a plurality of touch points of a same hand, forming a contour of an area, the area or Graphic objects in the area will be selected;
the object which is pointed by fingertip or under the finger of the hand.

14. A method of intelligent switching sliding page operation and its characteristics is system according to the magnitude of the pressure applied by the fingers of the user on the screen and switch sliding operation corresponding to the operation effect.

15. A Human Computer Interaction method, user hold one or more finger touching the screen, call these touch points as J group of touch points, at this time, user uses another group of touch points respectively selecting more than one groups of objects in the same window of the J group of touch points, these selection operations will be treated as multiple selection, the system will select all of these groups of objects, the multiple selection mean that after the touch points select “B” group of objects, then the touch points selects the “C” group of objects, the former selected group, i.e. the “B” group of objects still in selected status rather than cancel the selected status of “B” group of objects, after all the touch points of J group leave a distance from the touch surface, the multiple selection mode will be ended, selection operations after that will not be treated as multiple selection.
